(19) United States
(12) Patent Application Publication
(10) Pub. No.: US 2025/0302120 A1
(43) Pub. Date: Oct. 2, 2025

(54) AEROSOL PROVISION DEVICE

(71) Applicant: NICOVENTURES TRADING LIMITED, London (GB)

(72) Inventors: Conor MCGRATH, London (GB); Jorge GOMEZ, London (GB); Matthew HOLDEN, London (GB); Jack GOODEVE, London (GB)

(21) Appl. No.: 18/863,153

(22) PCT Filed: May 5, 2023
(86) PCT No.: PCT/EP2023/061978

§ 371 Date: Nov. 5, 2024

(30) Foreign Application Priority Data
May 6, 2022 (GB) 2206647.6

(51) Int. Cl. A24F 40/70; A24F 40/465; A24F 40/60; H05B 6/10

(52) U.S. Cl. CPC A24F 40/70; A24F 40/465; A24F 40/60; H05B 6/108

(57) ABSTRACT

An aerosol provision device including a body; a chamber for receiving at least a portion of an article having aerosol generating material; an opening in the body communicating with the chamber; and at least a first cover member and a second cover member configured to move between a relatively closed position in which the first and second cover members are arranged to at least partially overlap the opening and a relatively open position in which the at least a portion of an article is able to pass through the opening; wherein the first and second cover members are biased relative to each other.

### RELATED APPLICATIONS

The present application is a National Phase entry of PCT Application No. PCT/EP2023/061978 filed May 5, 2023, which claims priority to GB Application No. 2206647.6 filed May 6, 2022, each of which is hereby incorporated by reference in their entirety.

### TECHNICAL FIELD

The present invention relates to an aerosol provision device. The present invention also relates to an aerosol provision system comprising an aerosol provision device and an article comprising aerosol generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

In accordance with some embodiments described herein, there is provided an aerosol provision device comprising a body; a chamber for receiving at least a portion of an article comprising aerosol generating material; an opening in the body communicating with the chamber; and at least a first cover member and a second cover member configured to move between a relatively closed position in which the first and second cover members are arranged to at least partially overlap the opening and a relatively open position in which the at least a portion of an article is able to pass through the opening; wherein the first and second cover members are biased relative to each other.

It will be understood that, as used herein, the terms “relatively open” and “relatively closed” when applied to the cover members, is intended to mean that the cover members are open or closed relative to each other. It will further be understood that this term encompasses the cover members being in a fully open position where the opening in the body is entirely exposed, and a fully closed position where the opening in the body is entirely covered.

The first and second cover members may be biased towards the relatively open position, alternatively, the first and second cover members may be biased towards the relatively closed position.

The first and second cover member may be arranged to translate between the relatively open and relatively closed positions.

The first cover member may comprise a first abutment face and the second cover member may comprise a second abutment face arranged to abut with each other in the relatively closed position.

The first and second cover members may be connected by a hinge.

The first cover member may comprise a first arm and the second cover member may comprise a second arm.

The hinge may act between the first and second arms.

The aerosol provision device may comprise a biasing arrangement configured to act between the first and second cover members.

The biasing arrangement may comprise a living hinge.

The biasing arrangement may comprise a spring. In embodiments, the spring may be a torsion spring.

The first and second cover members may be pivotally connected to the body, and may further be arranged to pivot between the relatively open and relatively closed positions.

The pivot axes of the first and second cover members may be coaxial.

The first and second cover members may be configured to fully close the opening in the relatively closed position. In the relatively closed position, the first and second cover members may abut each other.

The aerosol provision device may comprise an actuating member arranged to rotate on the body to actuate the first cover member and second cover member.

The actuating member may be arranged to at least partially receive the first and second cover members.

The actuating member may be configured to receive at least part of the body.

The actuating member may comprise a cam surface arranged to act on the first cover member.

The first cover member may comprise a blade.

The cam surface may act on the blade. In embodiments, the cam surface may act on the edge of the blade.

The cam surface may be arranged such that rotation of the actuating member in a first direction causes the cam surface to urge the first cover member towards the relatively closed position.

The cam surface may be a first cam surface and the actuating member may comprise a second cam surface arranged to act on the second cover member.

The blade may be a first blade and the second cover member may comprise a second blade. The second cam surface may act on the second blade

The actuating member may comprise a radial step adjacent to the or each cam surface to provide space to accommodate the or each blade in the relatively open position.

In accordance with some embodiments described herein, there is provided an aerosol provision device comprising: a body; a chamber for receiving at least a portion of an article comprising aerosol generating material; an opening in the body communicating with the chamber; a cover member arranged to move between a relatively closed position in which the cover member is arranged to restrict the at least a portion of an article from passing through the opening and a relatively open position in which the at least a portion of an article is able to pass through the opening; and an actuating member on the body, wherein the cover member is at least partially received in the actuating member; wherein the actuating member comprises an inner surface arranged to directly act on the cover member to move the cover member from the relatively open position to the relatively closed position.

In accordance with some embodiments described herein, there is provided a cover mechanism for an aerosol provision device comprising: a body; an opening in the body for receiving at least a portion of an article comprising aerosol generating material; and at least a first cover member and a second cover member configured to move between a relatively closed position in which the first and second cover members are arranged to at least partially overlap the opening and a relatively open position in which the at least a portion of an article is able to pass through the opening; wherein the first and second cover members are biased relative to each other.

In accordance with some embodiments described herein, there is provided a cover mechanism for an aerosol provision device comprising: a body; an opening in the body for receiving at least a portion of an article comprising aerosol generating material; a cover member arranged to move between a relatively closed position in which the cover member is arranged to restrict the at least a portion of an article from passing through the opening and a relatively open position in which the at least a portion of an article is able to pass through the opening; and an actuating member on the body, wherein the cover member is at least partially received in the actuating member; wherein the actuating member comprises an inner surface arranged to directly act on the cover member to move the cover member from the relatively open position to the relatively closed position.

In accordance with some embodiments described herein, there is provided an aerosol provision system comprising an aerosol provision device as described in any of the above, or a cover mechanism as described in any of the above; and an article comprising aerosol-generating material.

### BRIEF DESCRIPTION OF THE DRAWINGS

Embodiments of the invention will now be described, by way of example only, with reference to accompanying drawings, in which:

FIG. 1 shows a front view of an aerosol provision device;

FIG. 2 shows a schematic cross-sectional side view of the aerosol provision device of FIG. 1;

FIG. 3 shows a close up perspective view of part of the aerosol provision device of FIG. 1 focussing on a cover mechanism;

FIG. 4 shows a plan view of part of the aerosol provision device and cover mechanism of FIG. 3;

FIG. 5 shows a schematic profile view of first and second cover members of the cover mechanism shown in FIG. 3;

FIG. 6 shows cut-away plan view of the cover mechanism of FIG. 3 in a closed position;

FIG. 7 shows a cut-away plan view of the cover mechanism of FIG. 3 in an open position;

FIG. 8 shows a schematic cross sectional profile view of the cover mechanism of FIG. 3 in a closed position; and

FIG. 9 shows a perspective view of an actuating member of the cover mechanism of FIG. 3.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavorants. Aerosol-generating material may include any plant based material, such as tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt % or 70 wt % of amorphous solid, to about 90 wt %, 95 wt % or 100 wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energized so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

An aerosol generating device can receive an article comprising aerosol generating material for heating. An “article” in this context is a component that includes or contains in use the aerosol generating material, which is heated to volatilize the aerosol generating material, and optionally other components in use. A user may insert the article into the aerosol generating device before it is heated to produce an aerosol, which the user subsequently inhales. The article may be, for example, of a predetermined or specific size that is configured to be placed within a heating chamber of the device which is sized to receive the article.

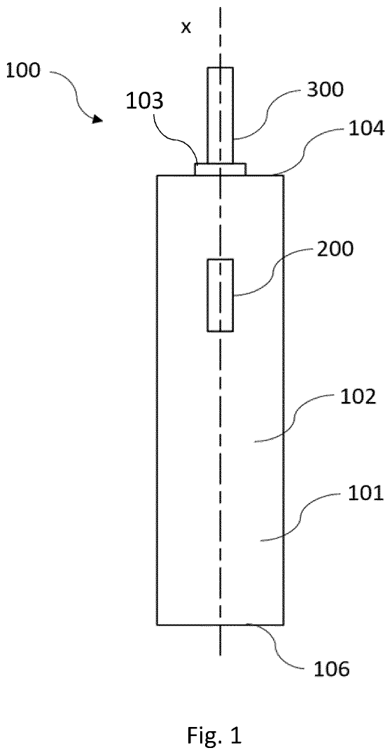

FIG. 1 shows an aerosol provision device 100 for generating aerosol from an aerosol generating material. In broad outline, the device 100 may be used to heat a replaceable article 300 comprising the aerosol generating material, to generate an aerosol or other inhalable medium which is inhaled by a user of the device 100. The article 300 and the device 100 together form an aerosol provision system.

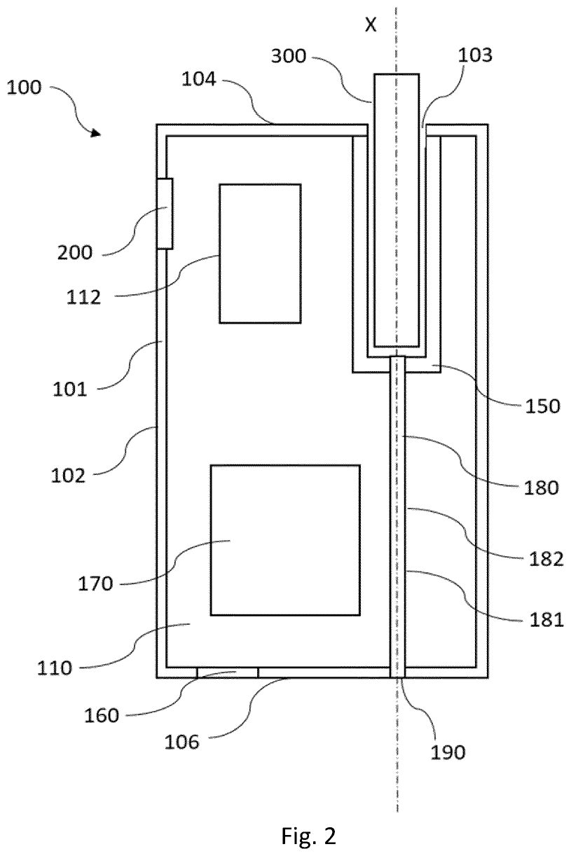

The device 100 comprises a body 101. A housing 102 surrounds and houses various components of the body 101. An opening 103 is formed at one end of the body 101, through which the article 300 may be inserted for heating by an aerosol generator 150 (refer to FIG. 2). In use, the article 300 may be fully or partially inserted into the aerosol generator 150 where it may be heated by one or more components of the aerosol generator 150.

The device 100 also includes a button assembly 200, which operates the device 100 when pressed. For example, a user may turn on the device 100 by operating the button assembly 200.

The aerosol generator 150 defines a longitudinal axis X.

FIG. 2 shows a schematic cross sectional view of the device 100. The device 100 comprises an electrical component, such as a connector/port 160, which can receive a cable to charge a battery of the device 100. For example, the connector 160 may be a charging port, such as a USB charging port. In some examples the connector 160 may be used additionally or alternatively to transfer data between the device 100 and another device, such as a computing device.

The device 100 comprises a power source 170, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The battery is electrically coupled to the aerosol generator 150 to supply electrical power when required and under control of a controller to heat the aerosol generating material.

The device 100 comprises an electronics module 112. The electronics module 112 may comprise, for example, a printed circuit board (PCB). The PCB may support at least one controller, such as a processor, and memory. The PCB may also comprise one or more electrical tracks to electrically connect together various electronic components of the device 100. For example, the battery terminals may be electrically connected to the PCB so that power can be distributed throughout the device 100.

The body 101 has end surfaces of the device 100. The end of the device 100 closest to the opening 103 may be known as the proximal end (or mouth end) 104 of the device 100 because, in use, it is closest to the mouth of the user. In use, a user inserts an article 300 into the opening 103, operates the aerosol generator 150 to begin heating the aerosol generating material and draws on the aerosol generated in the device. This causes the aerosol to flow through the device 100 along a flow path towards the proximal end of the device 100.

The other end of the device furthest away from the opening 103 may be known as the distal end 106 of the device 100 because, in use, it is the end furthest away from the mouth of the user. As a user draws on the aerosol generated in the device, the aerosol flows in a direction towards the proximal end of the device 100. The terms proximal and distal as applied to features of the device 100 will be described by reference to the relative positioning of such features with respect to each other in a proximal-distal direction along the longitudinal axis.

As used herein, one-piece component refers to a component of the device 100 which is not separable into two or more components following assembly of the device 100. Integrally formed relates to two or more features that are formed into a one-piece component during a manufacturing stage of the component.

An air flow passage 180 extends through the body 101. The airflow passage 180 extends to an air inlet 190.

In one example, the aerosol generator 150 comprises an induction-type heating system, including a magnetic field generator. The magnetic field generator comprises an inductor coil assembly. The aerosol generator 150 comprises a heating element. The heating element is also known as a susceptor.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

The aerosol generator 150 is an inductive heating assembly and comprises various components to heat the aerosol generating material of the article 300 via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

The inductor coil assembly includes an inductor coil. In embodiments, the number of inductor coils differs. In embodiments, a two or more inductor coils are used. The inductor coil assembly also comprises a coil support. The coil support is tubular.

The heating element is part of a heating assembly. The heating element of this example is hollow and therefore defines at least part of a receptacle within which aerosol generating material is received. For example, the article 300 can be inserted into the heating element. The heating element is tubular, with a circular cross section. The heating element has a generally constant diameter along its axial length.

In embodiments, the heating assembly defines the receptacle and the heating element upstands in the receptacle.

The heating element is formed from an electrically conducting material suitable for heating by electromagnetic induction. The susceptor in the present example is formed from a carbon steel. It will be understood that other suitable materials may be used, for example a ferromagnetic material such as iron, nickel or cobalt.

In other embodiments, the feature acting as the heating element may not be limited to being inductively heated. The feature, acting as a heating element, may therefore be heatable by electrical resistance. The aerosol generator 150 may therefore comprise electrical contacts for electrical connection with the apparatus for electrically activating the heating element by passing a flow of electrical energy through the heating element.

The receptacle and article 300 are dimensioned so that the article 300 is received by the heating element. This helps ensure that the heating is most efficient. The article 300 of this example comprises aerosol generating material. The aerosol generating material is positioned within the receptacle. The article 300 may also comprise other components such as a filter, wrapping materials and/or a cooling structure.

The air flow passage 180 extends from the receptacle. The air flow passage 180 is at the distal, end. The air flow passage 180 protrudes from the heating element. The air flow passage 180 extending from the heating element is defined by a flow path member 182. The heating element 220 and the flow path member 182 forms part of an airflow path arrangement 181.

The flow path member 182 extends between the heating element and the opening 190. The flow path member 182 is tubular. The flow path member 182 defines a bore. The flow path member extends in an axial direction along its length.

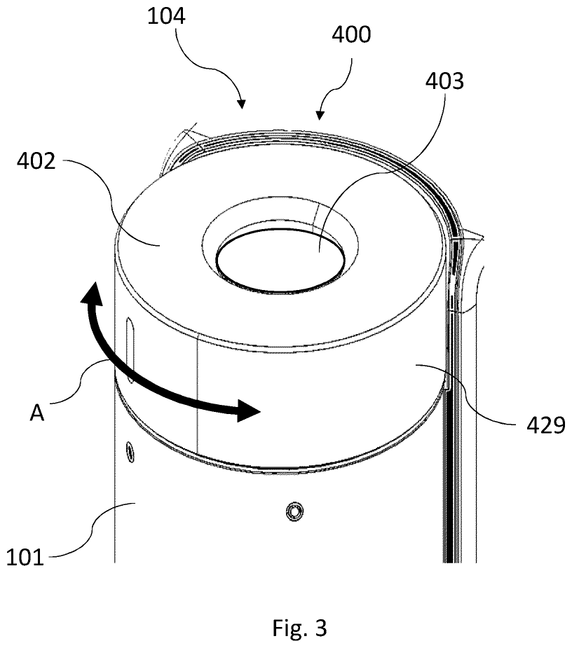

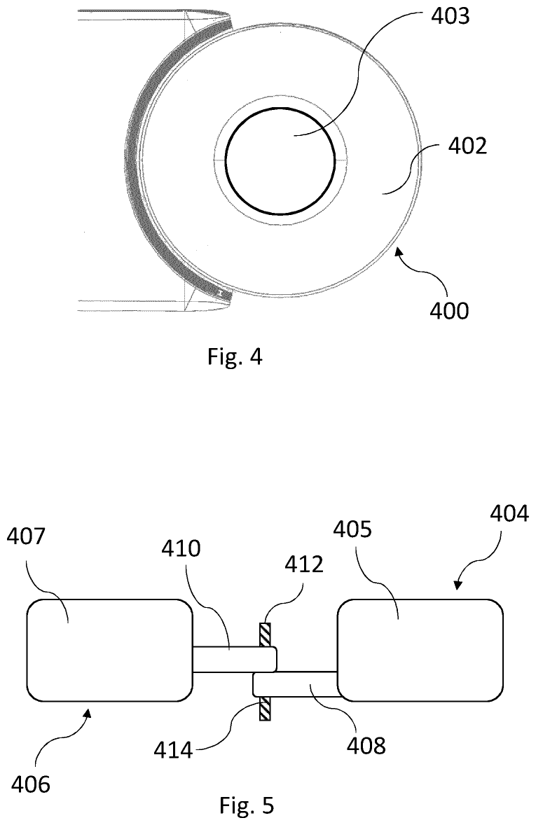

FIGS. 3 and 4 show a perspective view and plan view respectively of the proximal end 104 of an aerosol provision device. The views of FIGS. 3 and 4 focus on a cover mechanism 400 which is provided at the proximal end of the body, and is arranged to cover the opening 103, when the cover mechanism 400 is in its closed configuration. The cover mechanism 400 comprises an actuating member 402 which is rotatably mounted on the body 101 such that a user is able to rotate the actuating member 402 as shown by arrow A in FIG. 3. The actuating member 402 is moveable in one direction to move the cover mechanism 400 into the relatively open configuration, and in an opposing direction to move the cover mechanism 400 into the relatively closed configuration. The actuating member 402 has a cylindrical shape, with a central aperture 403 which aligns with the opening 103 provided in the body 101.

FIG. 5 shows a schematic profile view of a first cover member 404 and a second cover member 406. The cover mechanism 400 includes the first and second cover members 404, 406. The first cover member 404 comprises a first blade 405. A first arm 408 extends from the first blade 405. The second cover member 406 comprises a second blade 407. A second arm 410 extends from the second blade 407. The first and second arms 408, 410 are joined by pivot 412. As can be seen from FIG. 5, the first and second arms 408, 410 are vertically offset from each other such that the arms can overlap at the location of the pivot 412 whilst maintaining the first and second blades 405, 407 at the same height. At the pivot, a torsion spring 414 is provided to bias the first and second cover members 404, 406 apart.

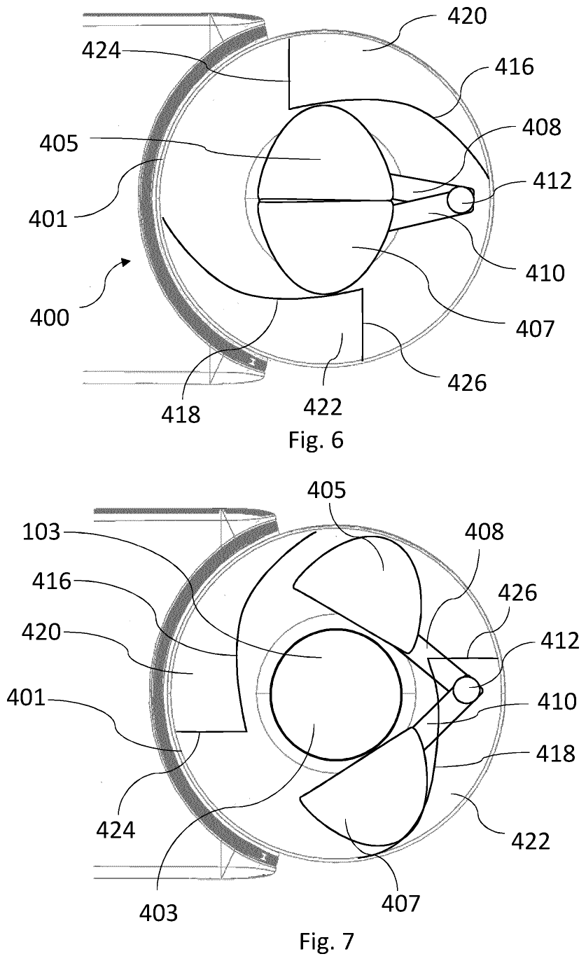

FIGS. 6 and 7 show a cut-away plan view of the cover mechanism 400, in a closed and open configuration respectively. In the illustrated embodiment the blades 405, 407 are approximately semi-circular in shape and are sized to fully cover the aperture 403 when abutting each other. The first and second cover members are pivotally mounted to the body 101 via the first and second arms 408, 410. The first and second arms 408, 410 are each mounted to the body 101 by pivot 412 such that the pivot axes of the first and second cover members 404, 406 are co-axial. The first and second cover members 404, 406 are connected to each other by a hinge provided by the pivot 412, or by other hinge means, such that the cover members 404, 406 are able to pivot towards and away from each other. A biasing arrangement is provided between the first and second arms 408, 410 such that the first and second cover members are biased away from each other. As can be seen from FIGS. 6 and 7, when the first and second cover members 404, 406 are urged together, as shown in FIG. 5, the first and second blades 405, 407 are arranged to overlap, and hence close, the opening 103. Accordingly, debris is restricted from entering the opening 103. Meanwhile, when the first and second cover members 404, 406, are distal from each other, as shown in FIG. 6, they are arranged to be free from overlapping the opening 103, such that the opening 103 is open and can receive an article 300. In embodiments, the first and second cover members 404, 406 may partially overlap the opening 103 in the open position, but this overlapping should be minor enough to allow an article 300 to be inserted into the opening 103. In the illustrated embodiment, the first and second cover members 404, 406 are abutting in the closed position, but in some embodiments, the first and second cover members 404, 406 may be arranged to partially overlap each other in the closed position. In such embodiments, the first and second cover members 404, 406 may be vertically offset in order to allow them to overlap each other.

In the illustrated embodiment, the biasing arrangement is provided by a torsion spring 414 provided at the pivot 412. The torsion spring 414 is connected to both the first arm 408 and the second arm 410. The torsion spring 414 is configured to bias the first and second cover members 404, 406 away from each other, into the open position.

In embodiments, the biasing arrangement is provided by a living hinge joining the first and second arms 408, 410. It will be understood that a living hinge comprises a hinge formed from an extension of the parent material. In the present case, the first and second arms may be integrally formed, and the point at which the first and second arms meet may be at least one of machined or formed, for example by being thinned or cut, in order to provide the necessary flexibility to allow the first and second cover members 404, 406 to move relative to each other. Although the illustrated embodiment shows the pivot 412, it will be understood that where a living hinge is provided, the first and second arms 408, 410 may not need to be pivotally mounted to the body in order to allow the first and second cover members 404, 406 to move relative to each other. In embodiments, each of the first and second arms 408, 410 are fixedly mounted to the body 101 at the location of the living hinge since the flexibility of the living hinge itself allows the movement, even in the absence of a pivot 412.

FIGS. 6 and 7 illustrate first and second cam surfaces 416, 418 provided by the actuating member 402. The first and second cam surfaces 416, 418 are provided on an interior surface 401 of the actuating member 402, and are formed by arcuate protrusions 420, 422. In embodiments, the cam surfaces are linear. The protrusions 420, 422 have a gradually increasing thickness, such that as the actuating member is rotated, for example in a clockwise direction relative to the body, and hence the first and second cover members 404, 406, the first cover member 404 contacts portions of the first cam surface 416 which are incrementally closer to the central opening 103. The second cover member 404 and the second cam surface 418 have a corresponding arrangement. As such, the protrusions 420, 422, and hence the first and second cam surfaces 416, 418 formed by the protrusions 420, 422, are shaped to act on the edges of the first blade 405 and the second blade 407 to urge the first and second cover members 404, 406, towards each other and into the closed position when the actuating member 402 is rotated clockwise by a user. It will be understood that in other embodiments, the protrusions 420, 422, and cam surfaces 416, 418 could be shaped to urge the first and second cover members 404, 406 into the closed position when the actuating member 402 is rotated anti-clockwise. Stops (not shown) may limit rotation of the actuating member. In embodiments, interacting surfaces of one or both cam surfaces 416, 418 and the cover members 404, 406 may act as stops.

As best illustrated in FIG. 7, the curved protrusions 420, 422 of the actuating member 402 comprise first and second radial steps 424, 426 adjacent to the first and second cam surfaces 416, 418 respectively. In between the first radial step 424, and the second cam surface 418, a space is formed to accommodate the blade 407. In between the second radial step 426, and the first cam surface 418, a space is formed to accommodate the first blade 405.

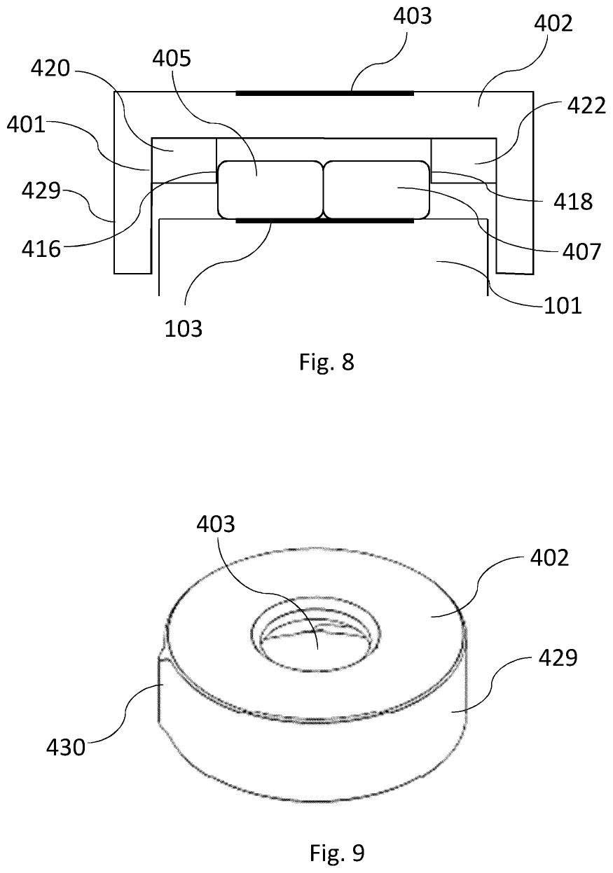

FIG. 8 shows a cross-sectional profile view of the cover mechanism 400 mounted on the body 101. The actuating member 402 is shaped as a cylinder open at one end. At its open end, the actuating member 402 receives a portion of the body 101 such that the actuating member is rotatably mounted on the body 101. The actuating member 402 may be held on the body in any known way, such as by cooperating protrusions and slots, clips, or ball bearings (not shown). The first and second curved protrusions 420, 422 are formed as steps protruding from the inner circumferential surface 401 of the actuating member 402. FIG. 8 shows the cover mechanism 400 in the closed configuration. It can be seen that the first and second curved protrusions 420, 422 are in contact with the edges of the first and second blades 405, 407, and have urged them into contact with each other, and hence into the closed position. The first and second blades 405, 407 are completely covering the opening 103 in the body 101.

FIG. 9 shows a perspective view of the actuating member 402. In the embodiment illustrated by FIG. 9, the actuating member 402 comprises a vertical ridge 430 on its outer circumferential surface 429. The ridge 430 may aid a user in gripping the actuating member 402 in order to rotate the actuating member 402.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision device comprising:
a body;
a chamber for receiving at least a portion of an article comprising aerosol generating material;
an opening in the body communicating with the chamber; and
at least a first cover member and a second cover member configured to move between a relatively closed position in which the first and second cover members are arranged to at least partially overlap the opening and a relatively open position in which the at least a portion of an article is able to pass through the opening;
wherein the first and second cover members are biased relative to each other.

2. The aerosol provision device of claim 1, wherein the first and second cover members are biased towards the relatively open position.

3. The aerosol provision device of claim 1, wherein the first and second cover members are connected by a hinge.

4. The aerosol provision device of claim 3, wherein the first cover member comprises a first arm and the second cover member comprises a second arm.

5. The aerosol provision device of claim 4, wherein the hinge acts between the first and second arms.

6. The aerosol provision device of claim 1, comprising a biasing arrangement configured to act between the first and second cover members.

7. The aerosol provision device of claim 6, wherein the biasing arrangement comprises a living hinge.

8. The aerosol provision device of claim 6, wherein the biasing arrangement comprises a spring.

9. The aerosol provision device of claim 1, wherein the first and second cover members are pivotally connected to the body, and are arranged to pivot between the relatively open and relatively closed positions.

10. The aerosol provision device of claim 9, wherein pivot axes of the first and second cover members are coaxial.

11. The aerosol provision device of claim 1, wherein the first and second cover members are configured to fully close the opening in the relatively closed position.

12. The aerosol provision device of claim 1, comprising an actuating member arranged to rotate on the body to actuate the first cover member and second cover member.

13. The aerosol provision device of claim 12, wherein the actuating member is arranged to at least partially receive the first and second cover members.

14. The aerosol provision device of claim 12, wherein the actuating member is configured to receive at least part of the body.

15. The aerosol provision device of claim 12, wherein the actuating member comprises a cam surface arranged to act on the first cover member.

16. The aerosol provision device of claim 15, wherein the cam surface is arranged such that rotation of the actuating member in a first direction causes the cam surface to urge the first cover member towards the relatively closed position.

17. The aerosol provision device of claim 15, wherein the cam surface is a first cam surface and the actuating member comprises a second cam surface arranged to act on the second cover member.

18. The aerosol provision device of claim 15, wherein the actuating member comprises a radial step adjacent to the or each cam surface to provide space to accommodate the or each blade in the relatively open position.

19. An aerosol provision device comprising:
a body;
a chamber for receiving at least a portion of an article comprising aerosol generating material;
an opening in the body communicating with the chamber;
a cover member arranged to move between a relatively closed position in which the cover member is arranged to restrict the at least a portion of an article from passing through the opening and a relatively open position in which the at least a portion of an article is able to pass through the opening; and
an actuating member on the body, wherein the cover member is at least partially received in the actuating member;
wherein the actuating member comprises an inner surface arranged to directly act on the cover member to move the cover member from the relatively open position to the relatively closed position.

20. An aerosol provision system comprising the aerosol provision device of claim 1; and an article comprising aerosol-generating material.
